(19) United States
(12) Patent Application Publication
(10) Pub. No.: US 2009/0083410 A1
(43) Pub. Date: Mar. 26, 2009

(54) INFORMATION NOTIFICATION SYSTEM, UPDATE INFORMATION NOTIFICATION METHOD, AND TERMINAL UNIT

(75) Inventor: Mitsuhiro KIZU, Hyogo (JP)

Correspondence Address: HAMRE, SCHUMANN, MUELLER & LARSON P.C., P.O. BOX 2902-0902, MINNEAPOLIS, MN, 55402, US

(73) Assignee: Matsushita Electric Industrial Co., Ltd., Kadoma-shi (JP)

(21) Appl. No.: 12/211,518

(22) Filed: Sep. 16, 2008

(30) Foreign Application Priority Data
Sep. 20, 2007 (JP) 2007-243226

(51) Int. Cl. G06F 15/173; G06F 17/30

(52) U.S. Cl. 709/223; 707/100; 707/E17.005

(57) ABSTRACT

An information notification system of the present invention includes a server unit 100 and a plurality of terminal units 120a to 120c, the server unit 100 storing update information data 101a. The update information data 101a contains a filter description part 104b containing information that allows designation of terminal units within a particular range out of the plurality of terminal units 120a to 120c. The terminal units 120a to 120c include a control unit 122. The control unit 122 is capable of control to display the update information data 101a matching the filter description part 104b on a display unit 121. Based on such a configuration, only appropriate Web update information can be the subject of notification based on the model and configuration of a terminal unit of a user without using a special software program on the server's side.

### BACKGROUND OF THE INVENTION

1. Field of the Invention

The present invention relates to an information notification system for notifying a user of update information related to a user's terminal unit out of the update information of Web pages released on the Internet. The present invention also relates to a method for notifying of update information used by the information notification system. Particularly, the present invention relates to an information notification system and an update information notification method in which only update information related to a model of a user's terminal unit can be notified without using special software on the server's side.

2. Description of Related Art

Techniques for notifying of updates on Web pages to users have been commonly known. For example, Patent Document 1 (JP 2004-220375A) discloses a technique by which a user is notified of updates on Web pages by, for example, an e-mail.

Furthermore, in a known technique, information related to a user's terminal unit is collected via a network on the server's side, and based on the information obtained, useful information that can be used by the user is provided. For example, Patent Document 2 (JP 3139408B) discloses a technique in which information on configurations for each model of terminal units and on hardware and software owned by the user is recorded in a server, and then based on the record, useful information suitable for the user's environment is provided via a network.

However, when update information on Web pages related to terminal units simply is the subject of notification, as in the technique disclosed in Patent Document 1, information targeted to models and configurations of terminal units other than the user's terminal unit is also included. Thus, there has been a problem in that the user has to select information suitable for the model and configuration of the terminal unit he/she is currently using from the information received, which has been extremely troublesome.

Furthermore, in a configuration in which information on models and configurations of terminal units is collected and then suitable information is indicated, as in the technique disclosed in Patent Document 2, there has been a problem in that since special software has to be used by the server's side, the update information cannot be sent automatically.

### SUMMARY OF THE INVENTION

Therefore, with the foregoing in mind, it is an object of the present invention to notify only of suitable Web update information based on models and configurations of the user's terminal unit without using special software on the server's side.

An information notification system of the present invention includes a server unit and a plurality of terminal units, the server unit storing update information data related to the plurality of terminal units, and the plurality of terminal units capable of receiving the update information data via a network and displaying contents of the update information data, wherein the update information data contains a filter description part containing information that allows designation of terminal units within a particular range out of the plurality of terminal units. Each of the plurality of terminal units comprises a control unit, and the control unit determines whether or not the information contained in the filter description part matches that terminal unit, and when the information contained in the filter description part matches that terminal unit, controls to display the update information data matching the filter description part.

A first method for notifying of update information of the present invention includes the steps of:

storing, in a server unit, update information data containing a filter description part containing information that allows designation of terminal units within a particular range out of a plurality of terminal units;

downloading the update information data from the server unit and storing the update information data in the terminal unit;

determining whether or not that terminal unit satisfies conditions written in the filter description part contained in the update information data; and

when it is determined that that terminal unit satisfies the conditions, giving a command to display update information contained in the update information data.

A terminal unit of the present invention is capable of receiving update information data stored in a server unit via a network. The terminal unit includes: a control unit that gives a command to display update information contained in the received update information data, wherein the update information data contains a filter description part containing information that allows designation of terminal units within a particular range out of the plurality of terminal units, and the control unit determines whether or not the information contained in the filter description part matches that terminal unit, and when the information contained in the filter description part matches that terminal unit, gives a command to display update information contained in the update information data matching the filter description part.

A second method for notifying update information of the present invention includes the steps of:

downloading, from a server unit, update information data containing a filter description part containing information that allows designation of terminal units within a particular range out of a plurality of terminal units, and storing the update information data,

determining whether or not that terminal unit satisfies conditions written in the filter description part contained in the update information data, and

when it is determined that that terminal unit satisfies the conditions, giving a command to display update information contained in the update information data.

A medium of the present invention includes update information data, and the update information data includes a data structure containing a filter description part containing information that allows designation of terminal units within a particular range out of a plurality of terminal units.

According to the present invention, only information suitable for a user's terminal unit and its operating environment can be displayed upon presenting, to a user, Web page information related to a terminal unit and updated daily, and therefore the user does not have to be troubled by unnecessary information notification.

Furthermore, in the present invention, since only a general Web server software program is necessary on the server's side without using a special software program, the construction and management of the server can be made efficient, allowing a notification of update information on Web pages related to the terminal unit.

### BRIEF DESCRIPTION OF THE DRAWINGS

FIG. 1 is a schematic diagram illustrating a configuration of an information notification system in an embodiment of the present invention.

FIG. 2 is a block diagram illustrating a configuration of an information notification system in an embodiment of the present invention.

FIG. 3A is a schematic diagram illustrating an example of a record in the update information data in an embodiment of the present invention.

FIG. 3B is a schematic diagram illustrating an example of a record in the update information data in an embodiment of the present invention.

FIG. 4 is a flowchart illustrating operations of a control unit of a terminal unit in an embodiment of the present invention.

### DETAILED DESCRIPTION OF THE INVENTION

Hereinafter, the present invention will be described by way of illustrative embodiments with reference to the drawings.

Based on the above-described configuration as a basic configuration, an information notification system of the present invention may be embodied as described in the following. That is, in the information notification system of the present invention, the information contained in the filter description part may be configured to include a terminal unit's product number assigned by its manufacturer, or to include the product number and the serial number indicating the specific period when the terminal unit was manufactured.

Furthermore, in the information notification system of the present invention, the information contained in the filter description part may be configured to include a name of an operating system used by each of the terminal units, or to include a name of an operating system and version information.

### Embodiment

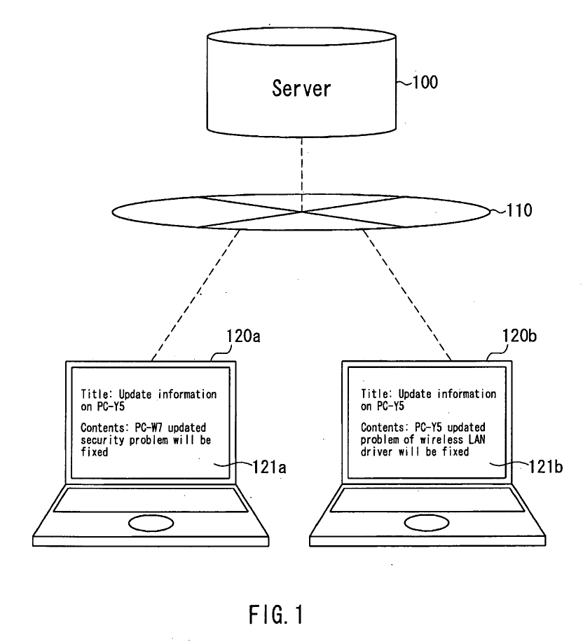

FIG. 1 illustrates a schematic configuration of the whole system for an information notification system in this embodiment. The information notification system includes a server unit 100 and terminal units 120a and 120b. The server unit 100 is connected to the terminal units 120a and 120b via the Internet 110, so that they are capable of mutual data communication.

The server unit 100 stores update programs provided by a program provider. The update programs are capable of updating, for example, an operating system (OS) and drivers for various peripheral devices installed in the terminal units 120a and 120b. The server unit 100 also stores update information data.

The terminal units 120a and 120b may be, for example, configured as a personal computer. In the terminal units 120a and 120b, a predetermined application software program for requesting update information data to the server unit is installed. Although the terminal units 120a and 120b are configured of models that are different from each other in this embodiment, the units may be the same model. The same OS may be installed in the terminal units 120a and 120b, or different OSs may be installed therein. The terminal units 120a and 120b are not limited to two units as shown in FIG. 1.

In the following, operations of an update information notification method of the information notification system in this embodiment are described briefly. For obtaining update information in each terminal unit, first, for example, a predetermined application software program installed in the terminal unit 120a is executed. By executing the application software program, the terminal unit 120a requests information (update information) concerning the presence or absence of an update program to the server unit 100. The server unit 100 is capable of providing, to the terminal unit 120a, update information data corresponding to the terminal unit 120a in response to the request from the terminal unit 120a. The terminal unit 120a is capable of displaying update information contained in the update information data provided from the server unit 100 on a display unit 121a. FIG. 1 illustrates an example of the update information displayed on the display unit 121a. As shown in FIG. 1, the update information displayed on the display unit 121a is, for example, a title and a summary of the update information.

Although details are omitted, the update information can be displayed on the terminal unit 120b as well in the same manner as with the terminal unit 120a. The server unit 100 provides update information data that is different depending on the model of the terminal unit, and therefore the contents of the update information displayed on the display unit 121a of the terminal unit 120a and the contents of the update information displayed on display unit 121b of the terminal unit 120b sometimes may be different. In the example display shown in FIG. 1, the terminal unit 120a and the terminal unit 120b are configured as models different from each other, and therefore the update information displayed on the display unit 121a and on the display unit 121b is different.

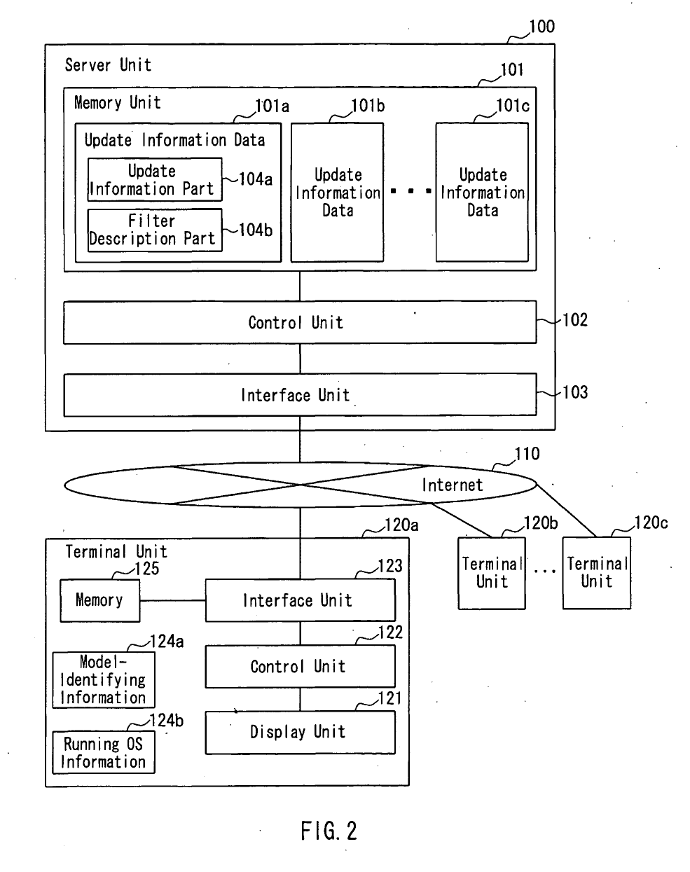

FIG. 2 is a block diagram illustrating a configuration of an information notification system in this embodiment. FIG. 2 illustrates detailed configurations of the server unit 100 and the terminal unit 120a as shown in FIG. 1.

As shown in FIG. 2, the server unit 100 includes a memory unit 101, a control unit 102, and an interface unit 103. The interface unit 103 is capable of connecting with the Internet 110. The memory unit 101 is capable of storing update information data 101a to 101c. The control unit 102 is capable of controlling the update information data 101a to 101c stored in the memory unit 101 to be sent to the Internet 110 via the interface unit 103. The control unit 102 controls the update information data 101a to 101c to be sent by using HTTP (Hyper-Text Transfer Protocol).

Each of the update information data 101a to 101c includes an update information part 104a and a filter description part 104b. The update information part 104a contains information such as a title, a summary, and a URL (Uniform Resource Locator) of the updated Web page. The filter description part 104b contains information (for example, a target model and a target OS) for the terminal unit to sort out the update information.

Each of the terminal units 120a to 120c has model-identifying information 124a that is unique to the model, such as a model number, and running OS information 124b. The model-identifying information 124a and the running OS information 124b are written in, for example, the BIOS (Basic Input Output System) of the terminal units 120a to 120c.

The terminal units 120a to 120c also include a display unit 121, a control unit 122, and an interface unit 123. The interface unit 123 is capable of connecting with the Internet 110. The control unit 122 has a function of sorting out the update information data 101a to 101c of the server unit 100 obtained via the Internet 110. The display unit 121 is capable of displaying at least the Web page update information. By displaying the Web page update information on the display unit 121, the user can be notified of the updates of the Web page.

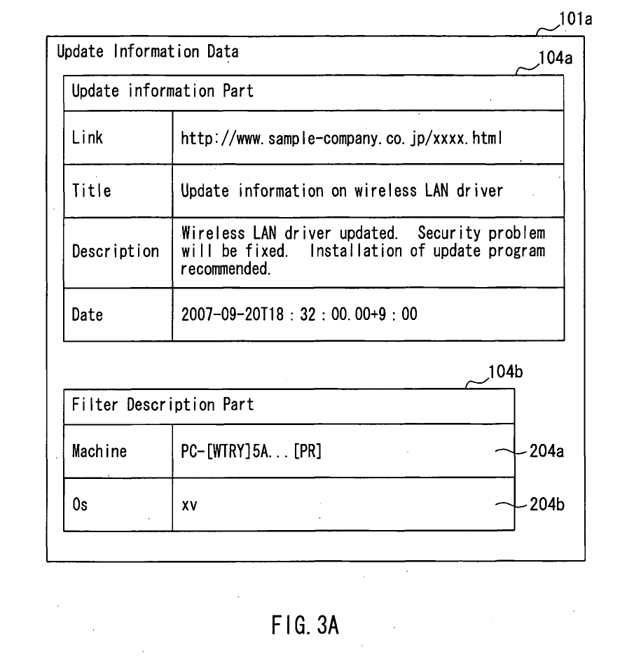

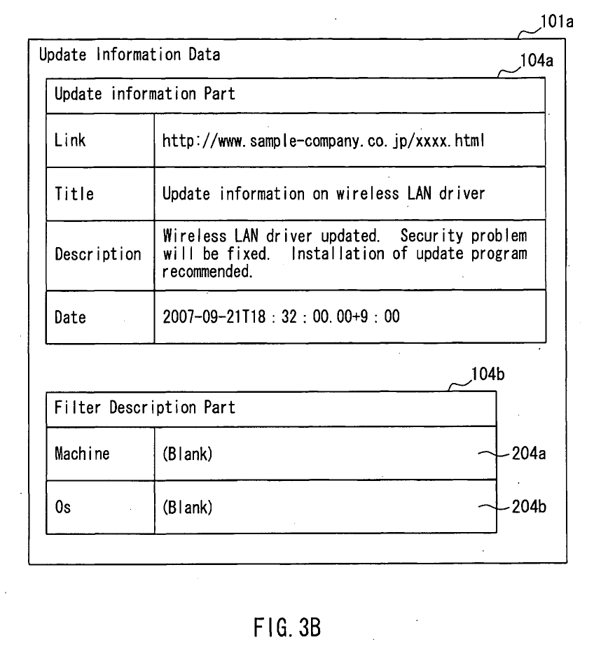

FIG. 3A and FIG. 3B are examples of a record of the update information data 101a to 101c in FIG. 2. FIG. 3A illustrates update information data in which a target model and a target OS are specified. FIG. 3B illustrates update information data in which a target model and a target OS are not specified. The update information part 104a in FIG. 3A and FIG. 3B is an element normally contained in the RSS (RDF (Resource Description Framework) Site Summary). The update information part 104a contains information of a URL (Link) of a supplier of the update information, a title (Title) of the update information, a summary (Description) of the update information, and a date (Date) of the update in this embodiment. The filter description part 104b contains a Machine field 204a and an OS field 204b. In the Machine field 204a, a character string of model-identifying information of a target model is written as a regular expression. In the OS field 204b, a type of a target running OS is written as a combination of symbols. The filter description part 104b is not contained in conventional update information data, and is a feature added by the present invention.

The “regular expression” is a method of expressing a set of character strings by a single character string. For example, in the case of the record shown in FIG. 3A, the Machine field 204a is expressed by a character string of ten figures, “PC-x5A . . . y”. The fourth figure “x” in this character string corresponds to one of “W”, “T”, “R”, and “Y” as shown in the square brackets in the Machine field 204a in FIG. 3A. That is, when the product number contained in the model-identifying information 124a of a terminal unit starts with, for example, “PC-W5A” or “PC-Y5A”, the update information data shown in FIG. 3A matches the terminal unit having such product numbers. The tenth figure in this character string, “y”, corresponds to one of “R” and “P”, as shown in the square brackets in the Machine field 204a of FIG. 3A. The dots (.) at the seventh to ninth figures in the character string show that no character string is specified. That is, with any character string at the seventh to ninth figures of the product number contained in the model-identifying information 124a of the terminal unit, the terminal unit matches the update information data shown in FIG. 3A, as long as other figures in the product number match the character string in the Machine field 204a.

As shown in FIG. 3B, when the Machine field 204a is blank, all the terminal units are matches, regardless of the model number contained in the model-identifying information 124a. Furthermore, as shown in FIG. 3B, when the OS field 204b is blank, all the OSs are matches, regardless of the types of the OS contained in the running OS information 124b. That is, update information data shown in FIG. 3B does not specify the model and the OS of the terminal unit, and is update information that can be provided to all the terminal units.

Although the filter description part 104b in this embodiment is configured of two fields, i.e., the Machine field 204a and the OS field 204b, other fields may be included. Examples of the field that can be contained in the filter description part 104b include, the serial number of the terminal unit, the ID number (ID:identification) of a battery loaded in the terminal unit, the version information of the BIOS, the version information of a driver, and the version information of a power control microcomputer mounted in the terminal unit.

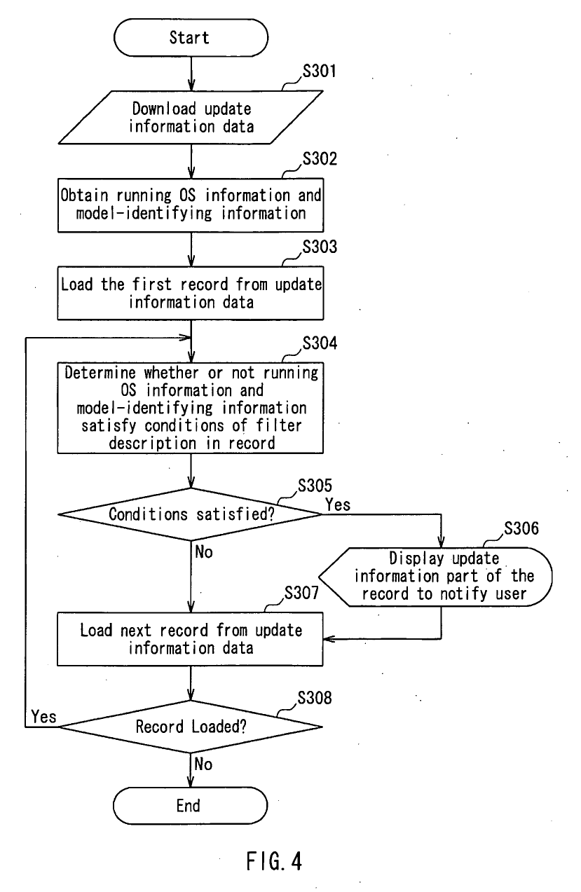

FIG. 4 illustrates processing of the control unit 122 in the terminal units 120a to 120c. The processing as shown in FIG. 4 is carried out automatically at regular intervals. Operations of receiving update information in the terminal unit 120a is described in the following.

First, the control unit 122 controls to download the update information data from the server unit 100 via the Internet 110 (S301). The control unit 122 controls to store the downloaded update information data in the memory 125 of the terminal unit 120a.

Then, the control unit 122 controls to obtain the running OS information 124b and the model-identifying information 124a contained in the BIOS of the terminal unit 120a, and to store the obtained information in the memory 125 (S302).

Then, control unit 122 controls to load the first record from the update information data stored in the memory 125 (S303).

Then, the control unit 122 reads the conditions written in the filter description part 104b in the record loaded from the memory 125. The control unit 122 determines whether or not the running OS information and the model-identifying information stored in the memory 125 satisfy the conditions read out from the filter description part 104b (S304).

Then, when the control unit 122 determines that the running OS information and the model-identifying information satisfy the conditions (YES in S305), display data is generated based on the update information part 104a. Then, the control unit 122 controls to display images based on the generated display data on the display unit 121. In this way, the user can be notified of the updates of information (S306).

When the control unit 122 determines that the running OS information and the model-identifying information do not satisfy the conditions (NO in S305), or after executing the process S306, a command is given to load the next record from the update information data stored in the memory 125 (S307). When the record can be loaded from the memory 125 (YES in S308), the process S304 is executed. Afterwards, the processing is executed in the same manner as described above. Meanwhile, when all the records are loaded from the update information data stored in the memory 125, the processing is completed, and no record can be loaded from the update information data (NO in S308), then the processing flow as shown in FIG. 4 is terminated.

As described above, according to the information notification system in this embodiment, with the addition of the filter description part 104b containing the Machine field 204a and the OS field 204b to the update information data 101a stored in the server unit 100, the information matching the terminal unit and its operation environment can be displayed. Therefore, users do not have to be troubled by unnecessary information notification upon checking information on Web pages related to the terminal unit and updated daily.

Furthermore, since only a general Web server software program is necessary on the server's side without a special software program in the information notification system in this embodiment, construction and management of the server can be made efficient, allowing a notification of update information on Web pages handling information related to the terminal unit.

The target model of the terminal unit may include a product number assigned by the manufacturer of the model, or the product number and the serial number indicating the specific period when the terminal unit was manufactured. The target OS may include a name of an OS, or the name of the OS and version information.

Furthermore, although the configuration in this embodiment was that the update information data including the filter description part was stored in the server unit and the terminal unit carries out a download via the Internet, in another possible configuration, the update information data may be recorded in an information medium including semiconductor memory or in a disc information medium, and may be distributed to users, for a user to carry out the update operation in his/her terminal unit. In this case, the medium for obtaining the update information data is just changed from a network to an information medium, and the actual updating operations can be carried out in the same manner as the processing S302 to S308 as shown in FIG. 4.

Furthermore, although the terminal unit includes a display unit in this embodiment, the terminal unit does not have to include the display unit. For example, in a possible configuration, the terminal unit may include an output terminal that can output display data, and a display device may be connected externally to the output terminal.

An information notification system of the present invention is effective in that upon automatically notifying update information on Web pages related to a user's terminal unit, only the information that matches the user's terminal unit and its environment can be displayed. Particularly, the present invention suitably is used in, for example, an information notification system in which updates of information related to a user's terminal unit is notified to the user out of the update information on Web pages released on the Internet.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. An information notification system comprising a server unit and a plurality of terminal units,
the server unit storing update information data related to the plurality of terminal units, and
the plurality of terminal units capable of receiving the update information data via a network and displaying contents of the update information data,
wherein the update information data contains a filter description part containing information that allows designation of terminal units within a particular range out of the plurality of terminal units,
each of the plurality of terminal units comprises a control unit, and
the control unit determines whether or not the information contained in the filter description part matches that terminal unit, and when the information contained in the filter description part matches that terminal unit, controls to display the update information data matching the filter description part.

2. The information notification system according to claim 1,
wherein the information contained in the filter description part includes a product number of the terminal unit assigned by a manufacturer, or the product number and a serial number indicating the specific period when the terminal unit was manufactured.

3. The information notification system according to claim 1,
wherein the information contained in the filter description part includes a name of an operating system used by each of the plurality of terminal units, or the name and version information of the operating system.

4. A method for notifying update information comprising the steps of:
storing, in a server unit, update information data containing a filter description part containing information that allows designation of terminal units within a particular range out of a plurality of terminal units;
downloading the update information data from the server unit and storing the update information data in the terminal unit;
determining whether or not that terminal unit satisfies conditions written in the filter description part contained in the update information data; and
when it is determined that that terminal unit satisfies the conditions, giving a command to display update information contained in the update information data.

5. A terminal unit capable of receiving update information data stored in a server unit via a network, comprising:
a control unit that controls to display update information contained in the received update information data,
wherein the update information data contains a filter description part containing information that allows designation of terminal units within a particular range out of a plurality of the terminal units, and
the control unit determines whether or not the information contained in the filter description part matches that terminal unit, and when the information contained in the filter description part matches that terminal unit, controls to display update information contained in the update information data matching the filter description part.

6. A method for notifying update information comprising the steps of:
downloading, from a server unit, update information data containing a filter description part containing information that allows designation of terminal units within a particular range out of a plurality of terminal units, and storing the update information data,
determining whether or not that terminal unit satisfies conditions written in the filter description part contained in the update information data, and
when it is determined that that terminal unit satisfies the conditions, controls to display update information contained in the update information data.

7. A medium comprising update information data,
wherein the update information data comprises a data structure containing a filter description part containing information that allows designation of terminal units within a particular range out of a plurality of terminal units.
